(19) United States
(12) Patent Application Publication
(10) Pub. No.: US 2002/0122135 A1
(43) Pub. Date: Sep. 5, 2002

(54) Apparatus for MPEG conversion

(75) Inventor: Koh Hiratsuka, Inzai-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NAGASE & CO., LTD., Osaka-shi (JP)

(21) Appl. No.: 10/044,227

(22) Filed: Jan. 10, 2002

(30) Foreign Application Priority Data
Mar. 1, 2001 (JP) 56625/2001

(51) Int. Cl. G06K 9/54; G06K 9/60; H04N 7/01; H04N 11/20; H04N 9/64

(52) U.S. Cl. 348/441; 348/720; 382/305

(57) ABSTRACT

An apparatus for MPEG conversion which converts digital video signals transferred from a digital video camera to a personal computer into MPEG data and writes converted data into an apparatus for keeping data, wherein the transferred digital video signals are temporarily written into a working area or, when the conversion cannot keep up with the transfer of the digital video signals, a portion of the digital video signals which cannot be processed by a real-time conversion into MPEG data is written into the working area while the conversion is conducted, and the digital video signals written into the working area are converted into MPEG data and then written into the apparatus for keeping data, the apparatus for MPEG conversion comprising: means for stopping transfer of the digital video signals by sending a command to the digital video camera when a capacity of the working area is completely occupied and means for starting transfer of the digital video signals by sending a command to the digital video camera when a vacancy is found in the capacity of the working area.

The apparatus can convert the transferred digital video signals to MPEG data and produce images of a high quality without frame drops without excessively occupying the disk space even when a low speed personal computer is used.

### BACKGROUND OF THE INVENTION

1. Field of the Invention

The present invention relates to an apparatus for MPEG conversion and, more particularly, to an apparatus which performs software conversion of digital video signals to MPEG data without frame drops by controlling operation of a video camera even when a low speed personal computer is used

2. Description of Related Art

To create MPEG data from a digital video camera which records images and sounds as digital data, the digital video camera and a personal computer are connected to each other via an IEEE 1394 connector. Heretofore, the digital data can be converted into MPEG data in accordance with one of the following two methods. In one method, the digital data in a prescribed amount are taken into a hard disk or the like other apparatus for keeping data as DV codec and the saved data are converted into MPEG data using a batch type software for conversion of AVI to MPEG 1/2/4 (the AVI-to-MPEG encoder). In the other method, the saved data are converted into MPEG 1/2/4 by the real-time conversion using a high speed personal computer and the converted data are written into a hard disk or the like other apparatus for keeping data while the conversion is conducted (the real time encoder).

The AVI-to-MPEG encoder has drawbacks in that DV data occupy a great amount of the disk space since the amount of DV data is much greater than the amount of MPEG data, that it takes time to process the data since the operation of conversion must be conducted after the entire data have been taken into the apparatus for keeping data and that, when the operation is conducted during the night, the operation produces AVI files of the DV codec alone and MPEG data cannot be produced directly.

The real time encoder has a drawback in that a personal computer or a work station which is operated under a high speed is necessary although a great advantage is exhibited in that MPEG files can be directly produced. Moreover, when the conversion into MPEG data cannot keep up with the transfer of the digital video signals, a problem arises in that frame drops are found or the quality of the images markedly deteriorates.

### SUMMARY OF THE INVENTION

The present invention has an object of providing an apparatus for MPEG conversion which can convert transferred digital video signals to MPEG data to produce images of a high quality without frame drops without excessively occupying the disk space even when a low speed personal computer is used and can continue processing the transferred data during the night so that MPEG data are provided next morning.

As the result of intensive studies by the present inventor, it was found that, in a system in which the digital video signals transferred from a digital video camera are temporarily written into a working area and the digital video signals written into the working area are then converted into MPEG data, MPEG data of a high quality can be obtained without frame drops, even when a low speed personal computer is used, by sending a command to the video camera in accordance with the condition of vacancy of the capacity of the working area and stopping or starting the transfer of the digital video signals. The present invention has been completed based on the knowledge.

The present invention provides:

(1) An apparatus for MPEG conversion which converts digital video signals transferred from a digital video camera to a personal computer into MPEG data and writes converted data into an apparatus for keeping data, wherein the transferred digital video signals are temporarily written into a working area or, when the conversion cannot keep up with the transfer of the digital video signals, a portion of the digital video signals which cannot be processed by a real-time conversion into MPEG data is written into the working area while the conversion is conducted, and the digital video signals written into the working area are converted into MPEG data and then written into the apparatus for keeping data, the apparatus for MPEG conversion comprising:

means for stopping transfer of the digital video signals by sending a command to the digital video camera when a capacity of the working area is completely occupied; and

means for starting transfer of the digital video signals by sending a command to the digital video camera when a vacancy is found in the capacity of the working area.

The preferred embodiments of the present invention include:

(2) An apparatus for MPEG conversion according to claim 1, wherein the working area is created in a hard disk; and

(3) An apparatus for MPEG conversion according to claim 1, wherein the working area is created in a main memory.

### DESCRIPTION OF THE PREFERRED EMBODIMENTS

The apparatus of the present invention is an apparatus for converting digital video signals transferred from a digital video camera to a personal computer into MPEG data and writing the converted data into an apparatus for keeping data. The apparatus for keeping data used in the apparatus of the present invention is not particularly limited. Examples of the apparatus for keeping data include an IC memory, a hard disk, CD-R/RW, +RW, DVD-RAM, DVD-R/RW/+RW, a floppy disk and a high density floppy disk which are disposed at the inside or the outside of the personal computer. The MPEG system used in the apparatus of the present invention is not particularly limited and any of MPEG1, MPEG2 and MPEG4 can be used.

In conversion of the digital video signals into MPEG data, the digital video signals transferred from a digital video camera to a computer are temporarily written into a working area or, when the conversion into MPEG cannot keep up with the transfer of the digital video signals, a portion of the digital video signals which cannot be processed by the real-time conversion into MPEG data is written into the working area while the conversion is conducted. The digital video signals written into the working area are converted into MPEG data and then written into the apparatus for keeping data. The apparatus of the present invention which is used for the above conversion of the digital video signals into MPEG data comprises means for stopping transfer of the digital video signals by sending a command to the digital video camera when a capacity of the working area is completely occupied and means for starting transfer of the digital video signals by sending a command to the digital video camera when a vacancy is found in the capacity of the working area. In the apparatus of the present invention, the working area for writing the digital video signals is not particularly limited. The working area may be created in a hard disk or in the main memory.

When the working area is created in a hard disk, an area for temporarily saving an AVI file (DV data) is manually or automatically created in a hard disk in the personal computer by a program or by the user. The transferred DV data are saved in this area and, when the area is completely occupied, a command is sent to the digital video camera via an IEEE 1394 connector and the transfer of the digital video signals is stopped. Thereafter, the DV data in the hard disk is converted into MPEG1, MPEG2 or MPEG4 using a software for MPEG conversion. The converted data are written into another area created as file 1.

When the data have been completely written into file 1, a message to resume the transfer of the digital video signals is sent to the digital video camera via the IEEE 1394 connector. The signals succeeding the signals processed above are transferred and overwritten into the working area in which the above DV data have been saved. When the working area in the hard disk is completely occupied with the succeeding signals, the transfer of the digital video signals is stopped and the conversion of the data into MPEG is conducted in the same manner as that described above. The converted data are written into another vacant area created as file 2.

The same procedures as those conducted above are conducted until processing of the desired DV data is completed. The entire MPEG files created above as files 1, 2 and so on are synthesized and a final MPEG file is created. The final MPEG file is written into a new area in the hard disk. When process of creating the final MPEG file has been completed, files 1, 2 and so on which are temporary files are eliminated.

When the working area is created in the main memory, the presence of the vacant area in the main memory is confirmed by the program and the vacant area is divided into field 1 and field 2. DV data transferred from the digital video camera is written into field 1. When field 1 is completely occupied, the route of writing is switched from field 1 to field 2 and the succeeding DV data transferred from the digital video camera is written into field 2 without stopping the transfer. While the DV data are being written into field 2, the DV data in field 1 are converted into MPEG1, MPEG2 or MPEG4 and the converted data are written into an area created as file 1 in the vacant area of the hard disk.

When the conversion of the data into MPEG and the writing of the converted data into the hard disk take so much time that field 2 is completely occupied with the DV data, a command is sent to the digital video camera via the IEEE 1394 connector and the transfer of the digital video signals is stopped. When the converted data have been completely written into file 1 in the hard disk, a message is sent to the digital video camera and the transfer of the digital video signals is resumed. While the DV data succeeding the data written into field 2 are written into field 1, the DV data in field 2 are converted into MPEG. When the conversion into MPEG is completed, the MPEG data are written into an area created as file 2 in the vacant area of the hard disk.

When the time for the conversion of the data into MPEG and the writing of the converted data into the hard disk is shorter than the time for the writing of the DV data transferred from the digital video camera into the main memory, the writing of the DV data and the conversion of the data into MPEG are continuously conducted without stopping the transfer of the digital video signals from the digital video camera. When the writing of the converted data into the hard disk does not keep up with the writing of the DV data into the main memory, a message is sent to the digital video camera and the transfer of the digital video signals is stopped until the MPEG data have been completely written into the hard disk.

When the conversion of the entire DV data into the MPEG data has been completed, the entire MPEG files created above as files 1, 2 and so on are synthesized and a final MPEG file is created. The final MPEG file is written into a new area in the hard disk. When process of creating the final MPEG file has been completed, files 1, 2 and so on which are temporary files are eliminated.

To summarize the advantages of the present invention, by using the apparatus for MPEG conversion of the present invention, the transferred digital video signals can be converted into MPEG data and images of a high quality are produced without frame drops without excessively occupying the disk space even when a low speed personal computer is used. Processing the transferred data can be continued during the night so that MPEG data are provided next morning.

What is claimed is:

1. An apparatus for MPEG conversion which converts digital video signals transferred from a digital video camera to a personal computer into MPEG data and writes converted data into an apparatus for keeping data, wherein the transferred digital video signals are temporarily written into a working area or, when the conversion cannot keep up with the transfer of the digital video signals, a portion of the digital video signals which cannot be processed by a real-time conversion into MPEG data is written into the working area while the conversion is conducted, and the digital video signals written into the working area are converted into MPEG data and then written into the apparatus for keeping data, the apparatus for MPEG conversion comprising:
means for stopping transfer of the digital video signals by sending a command to the digital video camera when a capacity of the working area is completely occupied; and
means for starting transfer of the digital video signals by sending a command to the digital video camera when a vacancy is found in the capacity of the working area.
